(19) United States
(12) Patent Application Publication
(10) Pub. No.: US 2007/0207533 A1
(43) Pub. Date: Sep. 6, 2007

(54) Device and method for collection and biodegradation of hydrocarbon fluids

(75) Inventor: W. Scott Callahan, Presto, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(73) Assignee: Callahan and Chase LLC

(21) Appl. No.: 11/367,962

(22) Filed: Mar. 3, 2006

(51) Int. Cl. A62D 3/02; A62D 101/20

(52) U.S. Cl. 435/262.5; 588/300; 588/405

(57) ABSTRACT

A portable, disposable device for the collection and bacteriological decomposition of liquid hydrocarbons including a pillow containing at least one member of the group consisting of (i) kenaf fibers/particles and (ii) a mixture of (a) natural, synthetic and/or oleophilic fibers/particles and (b)(i) one or more species of fungi selected from the group consisting of chaetonium indicum, chaetonium funicola, geotrichum candidum, macrophomina phaseolina, and trichoderma harziamum, and/or (b)(ii) one or more species of bacteria selected from the group consisting of bacillus subtillis, bacillus cereus sub group A and paenibacillus validus. The pillow may be quilted or otherwise constructed to define a plurality of chambers each containing the kenaf fibers/particles and/or the mixture of fibers/particles, fungi and/or bacteria. The device may further include a liquid impermeable pillow housing defining an opening to allow the liquid hydrocarbon to come into contact with the pillow. The pillow may define inter-connected channels for directing the flow of liquid hydrocarbons away from a contact point to evenly distribute the liquid hydrocarbons throughout the pillow. The upper and lower surfaces of the absorbent pillow may be constructed of different density fabric(s) and the pillow may define a sealed deflection area to further enhance the distribution of the liquid hydrocarbon throughout the pillow. A method of using the device includes the steps of: obtaining the device; placing the device proximate to a source of the liquid hydrocarbon and bringing the liquid hydrocarbon into contact with the device.

### TECHNICAL FIELD

The present invention relates to an absorbent device for use in the collection and biodegradation of spilled or leaked hydrocarbons.

More specifically, the present invention relates to an absorbent device to collect and biodegrade liquid hydrocarbons from motor vehicles and/or machinery in such a manner as to provide a variety of environmentally sound disposal options for such liquid hydrocarbons. As used herein, the terms biodegrade, bioremediate, degrade and the like refer to the process by which organic hazardous materials such as hydrocarbons are biologically degraded or “broken down”, usually into innocuous materials such as carbon dioxide, water, inorganic salts and/or bio-mass.

### BACKGROUND

### Brief Description of Related Art

In a broad range of applications, there is a need to remove, collect, contain, bioremediate and dispose of spent liquid hydrocarbons as part of the routine maintenance and operation of motor vehicles and a wide variety of other types of equipment and machinery that use oil and other liquid hydrocarbons for fuel and lubrication. This critically important task is necessary to prevent pollution of the environment, by for example, entry of pollutants into an adjacent water column as the spilled or leaked liquid hydrocarbons seep through the ground, or allowing the hydrocarbons to flow downstream as waste water runoff.

Common approaches to collecting liquid hydrocarbons from motor vehicles, equipment and the environment in general include metal and plastic drip pans and the like, as well as devices and substances like those disclosed in U.S. Pat. No. 4,684,562 to Hartkemeyer; U.S. Pat. No. 4,798,754 to Tomek; U.S. Pat. No. 5,186,831 to DePetris; U.S. Pat. No. 5,549,945 to Lind; U.S. Pat. No. 5,609,667 to Dickerson; U.S. Pat. No. 5,807,724 to Resnick; U.S. Pat. No. 5,906, 572 to Holland; U.S. Pat. No. 5,957,241 to Anderson; U.S. Pat. No. 6,573,087 to Lehr; U.S. Pat. No. 6,645,597 to Swain; U.S. Pat. No. 6,780,489 to Kingery; U.S. Pat. No. 6,899,940 to Leriget and D339,889 to Kessler et al.

U.S. Pat. No. 4,684,562 to Hartkemeyer teaches a mat for absorbing oil and other liquids comprising three sheets bonded together (by a sealing ring, tape, or adhesive), with one sheet formed from an absorbent, isotropically permeable material supported by a second sheet formed from an absorbent material for absorbing drippings. The two sheets further are supported by a third sheet that is liquid-resistant, one side of which is covered by a foil material further preventing liquid leakage.

U.S. Pat. No. 4,798,754 to Tomek discloses a lightweight, disposable oil absorbent floor mat adapted for placement beneath a motor vehicle or machine to catch oil, grease and other drippings. The Tomek mat comprises a generally rectangular base layer which is made up of an oil-impervious material, and a plurality of upper, oil-absorbent plies are interconnected to one another and superimposed on the base layer, the plies being made up of a highly absorbent paper or cellulose material. The plies of paper material are interconnected at spaced intervals and may be covered with an upper plastic layer which is perforated to permit any drippings to pass through the upper layer into the absorbent plies, the upper layer having an outer peripheral edge or edges sealed to the outer peripheral edges of the bottom layer to form a moisture barrier around the sides of the absorbent plies. Stiffener frame members may be interposed between the outer peripheral edges of the upper and base layers.

U.S. Pat. No. 5,186,831 to DePetris shows an oil sorbent product comprising an absorbent fiber core encapsulated in an adsorbent sheet, the adsorbent sheet being oleophilic, substantially hydrophobic, and capable of passing oil therethrough to the absorbent core.

U.S. Pat. No. 5,549,945 to Lind discloses an absorbent mat for absorbing oil and other liquid drippings beneath a motor vehicle, comprising a first bottom impervious flexible layer to be placed upon a support surface beneath the motor vehicle, a second intermediate absorbent flexible layer disposed upon the first bottom impervious layer and a third top permeable flexible layer disposed upon the second intermediate absorbent layer.

U.S. Pat. No. 5,609,667 to Dickerson (“Dickerson”) discloses a fine-powdered cellulose, containing essentially 3-8% of ammonium sulfate as nitrogen bearing nutrient, that forms a biologically active media which preferentially adsorbs hydrocarbons in the presence of water and supports the growth of naturally occurring hydrocarbon reducing bacterial forms resulting in rapid decomposition of the adsorbed hydrocarbons into water, carbon dioxide and other benign waste products. Dickerson discloses that a suitable form of such cellulose material is obtained as a by-product of de-linting cotton seed which was, as known in the art, treated with sulfuric acid forming, as a by-product, a sulfuric acid-containing cellulosic material comprising approximately 95% cellulose (the removed cotton lint) and approximately 5% sulfuric acid and further treated with ammonia to form a cellulose powder containing 5% (more or less) ammonium sulfate. Dickerson further teaches that the fine-powdered cellulose, containing essentially 3-8% of ammonium sulfate, is particularly suited for in situ remediation hydrocarbons from oil spills on land or in water by bacteriological decomposition.

U.S. Pat. No. 5,807,724 to Resnick (“Resnick”) discloses a device and method using organisms that degrade hydrocarbon-based substances encapsulated in wax to form organism-containing wax microshells used for removing oil-based substances such as oil spills on land and water. The organism taught by Resnick is of the genus Candida that produce lipase and the microshell may contain nutrients that sustain the organism. The wax is paraffin wax or beeswax, and the microshell may be coated with talc or carbon powder to provide insulation and to prevent one microshell from sticking to another. When used for remediating an oil spill on water, Resnick teaches that the microshells are preferably contained in a buoyant container, such as gas-filled microballoons, that acts as a flotation device.

U.S. Pat. No. 5,906,572 to Holland discloses a pillow-type device for collection and containment of spilled or leaked liquid hydrocarbons. The absorbed material is solidified-within the pillow into a rubber-like mass. An impermeable layer of material may be utilized in forming the bottom layer of the outer envelope of the device to retain accumulated hydrocarbons within the pillow while further allowing the contaminants to disperse throughout the device for absorption and solidification. The impermeable layer prevents spilled or leaked hydrocarbons from contaminating the surface below the device. The consolidated mass is easily retrieved and handled for disposal in a variety of ways including burial in a landfill.

U.S. Pat. No. 5,957,241 to Anderson teaches an oil drip mat apparatus for collecting oil which drips from motor vehicles and the like comprising a base member having a planar bottom mat portion and a beveled rim fastened to the top surface of the mat portion to define a holding area. A plurality of layers of material are disposed within the holding area, with each layer performing a specific function. Two of the layers are a detergent mixture layer for absorbing and breaking down the oil, one of the layers is an animal hair layer for further absorbing oil, and one layer is a porous, stiff fibrous layer which allows passage of oil therethrough.

U.S. Pat. No. 6,573,087 to Lehr (“Lehr”) discloses a packaged device comprising timed-release microorganisms and absorbent matrix for degradation of hydrocarbons. The Lehr package comprises a concentration of microorganisms, a timed-release mechanism including a time-release capsule, a matrix of fibrous material which is hydrophobic and oleophilic such as synthetic or cellulose fibers for storing accumulation of hydrocarbons, and a porous casing. The Lehr method comprises positioning a concentration of microorganisms capable of degradation of the hydrocarbons and filling the casing with the matrix to form a hydrocarbon containment and degradation package. Then the method employs the action of absorbing and storing hydrocarbons passing through the casing and wicking hydrocarbons via capillary action through the matrix and absorbing the hydrocarbons into the matrix where they come into contact with the microorganisms so that the liquid hydrocarbons can be degraded.

U.S. Pat. No. 6,645,597 to Swain discloses a containment floor mat for containing household liquid spills comprising a folded sheet that contains spilled liquids, and an absorption sheet which absorbs them. The absorption sheet is held in place by the containment sheet entirely by surface tension between the two sheets, and is therefore easily removed and replaced. The containment sheet is sewn in a folded configuration having interlocking corners, thus ensuring that there is no slit in the mat through which the liquids could escape. A fitted cover protects and holds the containment and absorption sheets together as a compact unit.

U.S. Pat. No. 6,780,489 to Kingery teaches a motor fluid absorbent pad comprising a bottom liquid impermeable support layer, a layer of absorbent material and a top liquid permeable layer, wherein a portion of the top liquid permeable layer is bonded to a portion of the bottom liquid impermeable support layer with an adhesive strip thereby enclosing the absorbent material layer. Kingery teaches that the absorbent pad can be made more environmentally friendly so as to be disposable in landfills by adding to the absorbent material layer an agent, such as an enzyme-based agent, for catalyzing the decomposition of the motor/engine oil.

U.S. Pat. No. 6,899,940 to Leriget teaches an absorbent mat assembly including a petroleum resistant mat having a bottom panel, a raised perimeter forming a recess, an absorbent pad placed within the recess, a fluid permeable backflow prevention member and a fluid permeable mesh placed over the absorbent pad and secured to the mat using a plurality of mesh connectors. The absorbent pad of Leriget may include a recyclable, washable and reusable material such as a polypropylene absorbent pad.

U.S. Pat. No. D339,889 to Kessler et al. (“Kessler”) discloses an oil absorbing pad of a generally square shape disposed in a housing having an opening covered by a mesh screen material.

The numerous absorbent devices and substances known for collecting and bioremediating liquid hydrocarbons, particularly from motor vehicles, machinery and the like, are relatively complex, do not effectively collect, retain and/or bioremediate the liquid hydrocarbons and are expensive to use and/or construct. These and other problems associated with such known methods and devices are overcome by the present invention.

### SUMMARY OF INVENTION

One aspect of the present invention is a portable, disposable device particularly suited for the collection and bacteriological decomposition of liquid hydrocarbons from motor vehicles, equipment, machinery and the like.

In accordance with the present invention, an absorbent device is provided which not only absorbs liquid hydrocarbons, but also degrades liquid hydrocarbons by bacteriological decomposition within a housing or envelope such that the device becomes substantially, if not completely, non-toxic after about 30 to 45 days and thus may be disposed of in a landfill or incinerated. Collected contaminants coming into contact with an interior side of the housing allows the device to disperse liquid hydrocarbons throughout an absorbent pillow for further absorption and degradation. The impermeable housing prevents spilled or leaked hydrocarbons from passing through the device and contaminating the surface below the device.

Another aspect of the present invention is a device for collecting and biodegrading a liquid hydrocarbon comprising a pillow comprising at least one member of the group consisting of (i) kenaf fibers/particles and (ii) a mixture of (a) organic, granular, synthetic and/or oleophilic fibers/particles and (b)(i) one or more species of fungi selected from the group consisting of chaetonium indicum, chaetonium funicola, geotrichum candidum, macrophomina phaseolina, and trichoderma harziamum, and/or (b)(ii) one or more species of bacteria selected from the group consisting of bacillus subtillis, bacillus cereus sub group A and paenibacillus validus. The pillow may preferably comprise a plurality of chambers each containing the kenaf fibers/particles and/or the mixture of fibers/particles, fungi and/or bacteria. Additionally, the pillow may be quilted to define the plurality of chambers and a plurality of inter-connected channels for directing the flow from a stream of liquid hydrocarbons away from such stream's point of contact with the pillow to evenly distribute the liquid hydrocarbons throughout the absorbent pillow. The absorbent pillow may further comprise materials of different densities and/or different surface areas making up its upper and lower surfaces and/or a sealed deflection area at the point of contact with a stream of liquid hydrocarbons to further enhance the distribution thereof throughout the pillow. The pillow preferably is made from a needle-punched, polypropylene or other oleophilic fabric. The device may further comprise a liquid impermeable housing preferably made from polyethylene that surrounds the pillow. The housing preferably defines an opening to allow the liquid hydrocarbon to come into contact with the pillow. The kenaf fibers/particles may preferably comprise inner core kenaf fibers/particles, outer bast kenaf fibers/particles or a mixture thereof.

Yet another aspect of the present invention is a method of collecting and degrading a liquid hydrocarbon, comprising the steps of: (1) obtaining a device adapted to accumulate and biodegrade a liquid hydrocarbon according to the present invention; (2) placing the device proximate a source of the liquid hydrocarbon to receive the liquid hydrocarbon directed thereto; and (3) bringing the liquid hydrocarbon into contact with the device.

Having briefly described the present invention, the above features and advantages thereof will be recognized by those skilled in the pertinent art from the following detailed description of the invention when taken in conjunction with the accompanying drawings.

### BRIEF DESCRIPTION OF THE DRAWINGS

For the present invention to be clearly understood and readily practiced, the present invention will be described in conjunction with the following figures which are incorporated into and constitute a part of the specification, wherein:

FIG. 1 is a perspective view of a preferred embodiment of an absorbent device of the present invention;

FIG. 2 is an exploded view of the absorbent device of FIG. 1; and

FIG. 3 is a cross sectional view of the absorbent device along line 3-3 of FIG. 2;

FIG. 4 is a perspective view of a another preferred embodiment of an absorbent device of the present invention.

### DETAILED DESCRIPTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description of the present invention and the preferred embodiment(s) thereof is set forth in detail below with reference to the attached drawings.

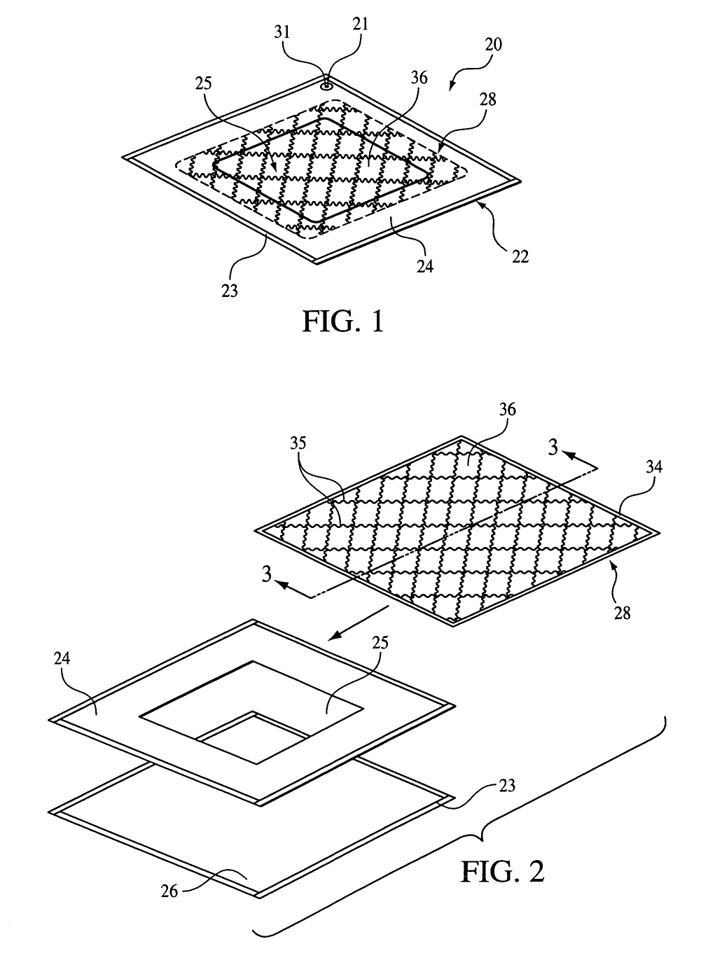

Referring now to the drawings, wherein like reference numerals designate corresponding structure throughout the views, FIG. 1 illustrates a preferred embodiment of a device of the present invention generally designated 20 that may be used to absorb and bioremediate liquid hydrocarbons from containment sumps, generally found beneath motor vehicles, equipment and machinery using liquid hydrocarbons for fuel and lubrication. The device 20 of the present invention may also be utilized in a wide variety of applications including, but are not limited to, removal of liquid hydrocarbons from electricity transformers, petrochemical pipelines, printing presses, aircraft, railroad equipment and fuel and lubricant containers.

The absorbent device 20 of the present invention preferably comprises an outer cover or housing 22 in which is removably disposed one or more pillows or pads 28, each configured to absorb and biodegrade up to about seven (7) quarts of liquid hydrocarbons such as motor oil. Housing 22 comprises an upper sheet 24 joined to a lower sheet 26 by heat or ultrasonic welding. The housing 22 preferably is generally square in shape and has dimensions of about 22″×22″. The seam 23 around the perimeter of the housing 22 is preferably about one-half inch in width. Both the upper sheet 24 and the lower sheet 26 are preferably made from a polymer material, such as an ultra linear low density polyethylene, generally impermeable to oil and other liquid hydrocarbons. Both the upper sheet 24 and the lower sheet 26 are preferably 6-12 mils in thickness and more preferably 8 mils in thickness. The upper sheet 24 defines a central opening 25 generally square in shape and preferably 13.75″×13.75″ to create the open envelope type housing or cover 22 as shown in FIG. 1. A grommet 21 is preferably disposed near the perimeter of the housing 22 to allow for the attachment of a string or rope 31 to provide for the easy retrieval of the device 20 from underneath motor vehicles, equipment and the like.

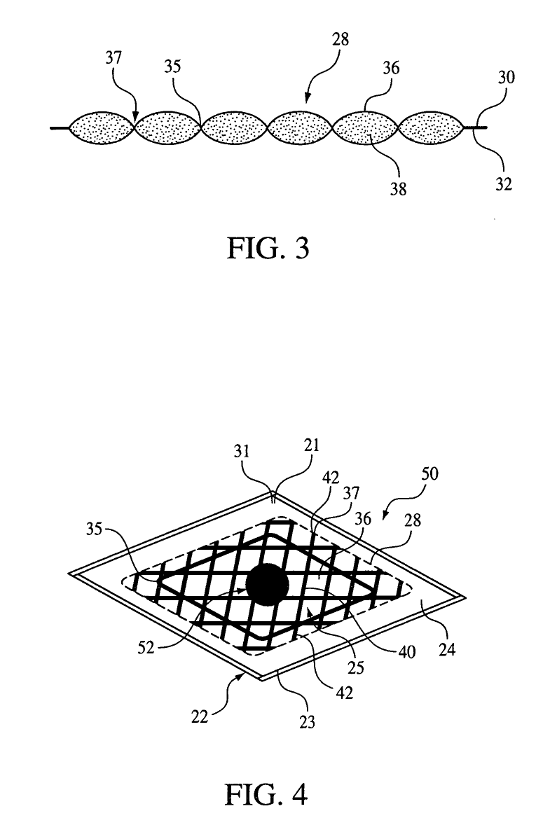

Pillow or pad 28 is preferably made from upper and lower sheets 30, 32 stitched together around the perimeter 34 and cross-stitched with a plurality of seams 35 to form a quilted pattern comprising a plurality of individual closed pockets or chambers 36 each containing a loose absorbent/bioremediating material 38, as shown in FIGS. 2 and 3. The seams 35 and pockets 36 also define a plurality of inter-connected channels 37 for channeling liquid hydrocarbons poured onto pillow 28 over and across the upper sheet 30 and into housing 22. As shown in FIGS. 1 and 4, a number of the plurality of inter-connected channels 37 lead to the perimeter 34 of pillow 28 which is located underneath the upper sheet 24 of housing 22. This preferred construction of the devices 20 and 50 of the present invention provides for the channeling of the liquid hydrocarbons over and through the upper sheet 30 and into, versus out of, the housing 22 thus minimizing the splashing of the liquid hydrocarbons into the surrounding environment. From the perimeter 34, the liquid hydrocarbons not absorbed/adsorbed by the upper sheet 30 flow into the interior of housing 22 where they are contained by the lower sheet 26 where they can be absorbed/adsorbed by the lower sheet 32 of pillow 28. The seams 35 and/or channels 37 may be constructed in a zig-zag pattern as shown in FIG. 1 or in any other desired pattern, such as the straight line seams 35 and channels 37 shown in FIG. 4 and/or intermittent line patterns in a regular or irregular pattern in a given direction. Intermittent line patterns may be used to further control the flow of the liquid hydrocarbons through channels 37 and over seams 35, particularly where the seams 35 have been formed by heat or ultrasonic welding to allow the liquid hydrocarbons to be absorbed/adsorbed along parts of the seams 35 similarly to the manner in which a stitched seam would perform in this regard.

The sheets 30, 32 preferably comprise a fabric such as melt-blown polypropylene or other textile material such as polyester or nylon and/or other oleophilic textile materials having a high affinity for absorbing liquid hydrocarbons. The fabric comprising sheets 30, 32 are also preferably needle-punched to increase the effective surface area of such fabric available for absorbing/adsorbing liquid hydrocarbons. Preferably, the upper sheet 30 comprises a 2.5 ounce (per unit area) needle-punched, melt-blown polypropylene fabric while the lower sheet 32 comprises a 6.0 ounce (per unit area) needle-punched, melt-blown polypropylene fabric. Preferably, the reduced density of the fabric of the upper sheet 30 provides less surface area in a given spot on sheet 30 for absorbing/adsorbing liquid hydrocarbons poured thereon, such as the point of contact where a stream of liquid hydrocarbons hits the sheet 30 when the device 20 is used to collect/bioremediate motor oil from a motor vehicle. This preferred construction of device 20 provides for some pooling of the liquid hydrocarbons on upper sheet 30 where such pool of liquid is channeled over seams 35 and through channels 37 over and across most of the area of upper sheet 30. The velocity of a stream of liquid hydrocarbons emanating from a motor vehicle engine disposed above the device 20 is likely to be high enough to provide the kinetic energy necessary to propel some of the liquid hydrocarbons hitting the upper sheet 30 through channels 37, under the upper sheet 24, beyond the perimeter 34 of pillow 28 and onto the lower sheet 26 of housing 22 where such liquid hydrocarbons can be absorbed/adsorbed by the lower sheet 32 of pillow 28. In this manner, the liquid hydrocarbons poured onto sheet 30 are efficiently distributed throughout the surface areas of both the upper and lower sheets 30 and 32, respectively, such that the liquid hydrocarbons are also efficiently distributed throughout the absorbent/bioremediating material 38 contained within the pillow 28. As a result, most, if not all, of the material 38 will be used in containing (with minimal leaching back into the housing 22 or surrounding environment) and biodegrading the liquid hydrocarbons.

The seams 35 of the pillow 28 may be disposed in a variety of orientations including, without limitation, on, parallel to, perpendicular to or at other angles across the longitudinal center axis of the pillow 28. Preferably, the quilting of the pillow 28 may be achieved by placing a plurality of seams 35 that cross the pillow 28 at oblique angles to one another so as to form the diamond-shaped pockets 36 as shown in FIGS. 1, 2 and 4. Other quilting designs, such as those creating square or rectangular pockets, may also be used. The addition of the seams 35 serves to produce a calculated number and arrangement of pockets 36 containing approximately equal amounts of the loose absorbent/bioremediating material 38. The design and spacing of the seams 35 creates a plurality of, inter-connected flow channels 37 for channeling the liquid hydrocarbons throughout the textile material of sheets 30, 32 and defines multiple compartmented absorption cells within each pocket 36 to facilitate and hasten the uniform distribution of the liquid hydrocarbons throughout the entire structure of the pillow 28, thus providing for the efficient bacterial remediation of the absorbed/adsorbed liquid hydrocarbons.

As shown in FIGS. 1 and 4, most of the inter-connected flow channels 37 preferably comprise a first portion 40 located opposite the opening 25 in sheet 24 and at least one, and often two, outer portions 42 disposed underneath the upper sheet 24 which run to the perimeter 34 of pillow 28. Thus, liquid hydrocarbons that come into contact with pillow 28 through opening 25 may flow through channels 37 from a point opposite of opening 25 underneath upper sheet 24 to the perimeter 34 and onto the lower sheet 26 of housing 22 where such liquid hydrocarbons can be absorbed/adsorbed by the lower sheet 32 of pillow 28.

The seaming of the sheet material components 30, 32, and the impermeable outer envelope 22 of the device 20, may be accomplished by several methods including mechanical stitching, thermal sealing and ultra-sonic fusing. These seaming methods may be used to seal the perimeter of the pillow 28 and produce the individual pockets 36.

371 The loose absorbent/bioremediating material 38 may be placed in the pillow 28 using several different methods. As a first preferred example, a layer of the loose material 38 is disposed between the sheets 30, 32, which are then stitched or welded around perimeter 34 and then cross-stitched or welded to form the pockets 36. The pillow 28 is then removably inserted into the housing 22 through opening 25 to create device 20 comprising a plurality of pockets 36 filled with the loose absorbent/bioremediating material 38.

Preferably, the loose absorbent/bioremediating material 38 comprises a mixture of fibers and/or particles, including ground or chipped plant cellulose, organic, granular and/or synthetic fibers/particles and further preferably including organic or synthetic oleophilic fibers and/or particles, and certain bacteria, fungi and/or nutrients (i.e., nitrogen, phosphorus, sulphur, oxygen, etc.) which may be indigenous to such fibers and/or employed as an additive thereto. The bacteria and fungi employed in a preferred embodiment of the present invention are as shown in Table 1 below.

TABLE 1

| | Percent colonization |
|---|---|
| Fungi | |
| Chaetonium indicum | 18 |
| Chaetonium funicola | 36 |
| Geotrichum candidum | 10 |
| Macrophomina phaseolina | 1 |
| Trichoderma harziamum | 1 |
| Bacteria | |
| Bacillus subtillis | 3 |
| Bacillus cereus sub group A | 3 |
| Paenibacillus validus | 1 |

Preferably, the loose absorbent material 38 comprises one or more members of the group consisting of (i) kenaf fibers/particles and (ii) a mixture of (a) organic, granular, synthetic and/or oleophilic fibers/particles and (b)(i) one or more species of fungi selected from the group consisting of chaetonium indicum, chaetonium funicola, geotrichum candidum, macrophomina phaseolina, and trichoderma harziamum, and/or (b)(ii) one or more species of bacteria selected from the group consisting of bacillus subtillis, bacillus cereus sub group A and paenibacillus validus.

Alternatively, the loose absorbent material 38 may preferably comprise kenaf (Hibiscus cannabinus L.) particles or fibers and/or a combination of kenaf particles/fibers and the mixture described immediately above. The stalk of the kenaf plant contains two different types of particles/fibers, outer “bast” particles/fibers and an inner “core” particles/fibers. The loose absorbent material 38 of the present invention may comprise particles/fibers from either or both of the outer bast or inner core of the kenaf plant. The kenaf particles/fibers contain the essential nutrients and certain specialized strains of bacteria and fungi listed above for the natural metabolization of various liquid hydrocarbons such as petroleum and polyaromatic hydrocarbons including without limitation acetone, ammonia, benzene, butanol, 2-butanone, bromoform, carbon disulfide, carbon tetrachloride, chloroform, chloromethane, chlorobenzene, cutting oils, dichlorobenzene, diesel fuels, ethanol, ethylbenzene, ethylene, gasoline, glycol, glycerine, hexane, hexachlorobenzene, isoprene, jet fuel, kerosene, methanol, methylene chloride, methylphenol, motor oil, naphthalen, nitrobenzene, pentane, phenol, propanol, styrene, tetrachloroethane, tetrachlorethylene, toluene, trichloroethylene, vinyl acetate, vinyl chloride. Additional nutrients and/or fertilizers may be used as required. The strong wicking action of the preferred kenaf particles/fibers draws the liquid hydrocarbon preferentially to itself and thereby provides enhanced absorption and bioremediation thereof. Further enhancement of the degradation of the absorbed liquid hydrocarbons may be obtained through the addition of various enzymes and/or emulsifiers to the loose material 38 in each pillow pocket 36 to ensure that the loose material 38 and the hydrocarbon are brought into intimate contact under conditions in which the loose material 38 will act to absorb and biodegrade the hydrocarbons.

The loose material 38 is preferably a 100% organic material such as kenaf fibers which are 100% biodegradable, non-toxic and highly absorbent. For example, the kenaf fibers will absorb up to 6 plus times their weight with extremely low leaching (less that 1%). The material 38 is preferably more oleophilic than the material making up the sheets 30, 32 of pillow 28. Tests have shown that the Toxicity Characteristic Leaching Potential (TCLP) of the preferred kenaf material is low. In one example, a sample of the kenaf material had an initial TPH (Total Petroleum Hydrocarbons) concentration of 750,000 ppm and only 160 ppm, or 0.02% TPH, leached out of the kenaf material. Incineration of the kenaf fibers 38 yields very low ash content (less that 2%) and high BTU rating (7500 BTU). The kenaf fibers 38 are not soluble in water, are hydrophobic, buoyant and have a weight/bulk density of 6-7 lbs. per cubic foot and a preferred particle size of standard Bin 3=minus ⅛″. Smaller, larger and/or mixed particle sizes of the kenaf fibers 38 may also be used. A preferred source of kenaf fibers for use in the present invention is commercially available from the Kengro Corporation 6605 Hwy 32 East, P.O. Box 432, Charleston, Miss. 38921 under the name Kengro Biosorb.

Each pillow 28 preferably contains between approximately 16 ounces to about 35 ounces of a loose kenaf material, such as the Kengro Biosorb, as the absorbent/bioremediating material 38. Preferably, the device 20 will absorb and biodegrade from about three (3) quarts up to about seven (7) quarts of a liquid hydrocarbon, such as motor oil, depending upon the amount of absorbent/bioremediating material 38 held by pillow 28. Larger or smaller versions of the device 20, however, may be constructed according to the present invention as required for a particular application. Ambient temperature and the viscosity of the liquid hydrocarbon to be absorbed and biodegraded are factors in determining the rate of absorption and the amount of time required to bioremediate the liquid hydrocarbons. The device 20 of the present invention is effective such that from about 30-45 days after being filled with one or more of the above-listed liquid hydrocarbons, the device is substantially, if not completely, non-toxic and able to be disposed of in a landfill or incinerated.

A forty five day study was conducted to evaluate the absorption capacity and bioremediation efficiency of Kengro Biosorb as the absorbent/bioremediating material 38 of the present invention. Twenty grams of the Kengro Biosorb (6% moisture content) was placed into each of four 500 cm3 disposable plastic containers (test units). 100 grams of non-detergent oil was added to matrices in each container to provide a 5/1 ratio of oil to Kengro Biosorb in a manner to achieve a thorough and uniform absorption by Kengro Biosorb particles. The moisture content was not monitored and kept at 6% during the duration of the study. One of the containers was placed in a freezer to prevent biological degradation/volatilization of the oil therein and also to serve as the reference material. The remaining three containers were kept exposed indoors due to low outside temperatures. 100 grams of oil were also placed in a separate container to evaluate volatilization. The Kengro Biosorb material soaked with oil in three indoor containers were aerated once a week by hand mixing. 1½ grams of sample from each test unit were mixed with sodium sulfate to remove water from matrices and were extracted for 16 hours using methylene chloride soxhlet method. Extracted samples were condensed, cleaned-up, and analyzed according to standard method 5520F. The amount of oil attached to the surface of the containers was negligible.

Results: Concentration levels and percent removal of non-detergent oil from Biosorb are summarized in Table 2 below.

TABLE 2
Concentration levels of oil in Kengro Biosorb (mg/kg) and
percent removal during a period of 45 days.

| | | % Removal vs. |
|---|---|---|
| Replicates | mg/kg | Starting Material |
| 1 | 880,000 | 83 |
| 2 | 875,000 | 83 |
| 3 | 905,000 | 82 |
| Starting | 5,100,000 | — |
| Material | | |
| Detection Level | 5,000 | — |

Each figure represents an average of two samples.

As summarized in Table 2, Kengro Biosorb showed both oil holding/soaking capacity and very good removal efficiency by degrading the oily compounds. Most of the degradation of the oil is likely attributable to biodegradation since the Kengro Biosorb carries a sizable population of microorganisms as described above. Also, volatilization was not a factor for this removal as evidenced by the lack of weight loss from the refrigerated reference material and due to the fact that the control sample of 100 grams of non-detergent oil placed next to the 3 test containers still weighed 100 grams on day 45.

In another preferred embodiment shown in FIG. 4, the device 50 of the present invention comprises a pillow 28 the upper surface 30 of which has a deflection portion 52 that has been sealed, by heat or ultrasonic techniques, so that liquid hydrocarbons poured onto portion 52 will be repelled or deflected into channels 37 and onto the area of the upper sheet 30 surrounding portion 52. The deflection portion 52 may also be constructed by attaching a non-absorbent material to pillow 28. This preferred construction of device 50 provides for the channeling of the liquid hydrocarbons over seams 35 and through the inter-connected channels 37 over and across most of the area of upper sheet 30, even where the device is used on a slight grade to receive liquid hydrocarbons poured from above onto portion 52 of upper sheet 30. For example, the velocity of a stream of liquid hydrocarbons emanating from a motor vehicle engine disposed above the device 50 is likely to be high enough to provide the kinetic energy necessary to propel the liquid hydrocarbons hitting the portion 52 of upper sheet 30 through channels 37 even such channels running uphill when the device 50 is used on a slight grade. Here again, some of the liquid hydrocarbons, particularly those running downhill will travel under, as opposed to over, the upper sheet 24, beyond the perimeter 34 of pillow 28 and onto the lower sheet 26 of housing 22 where such liquid hydrocarbons can be absorbed/adsorbed by the lower sheet 32 of pillow 28. In this manner, the liquid hydrocarbons poured onto sheet 30 are efficiently distributed throughout the surface areas of both the upper and lower sheets 30 and 32, respectively, even when the device 50 is used on a slight grade, such that the liquid hydrocarbons are efficiently distributed throughout the absorbent/bioremediating material 38 contained within the pillow 28. As a result, most, if not all, of the material 38 will be used in containing (with minimal leaching back into the housing 22 or surrounding environment) and biodegrading the liquid hydrocarbons.

A preferred method of collecting and degrading a liquid hydrocarbon according to the present invention comprises the steps of: (1) obtaining one of the devices as described herein adapted to accumulate and biodegrade a liquid hydrocarbon, such as a device comprising a pillow comprising at least one member of the group consisting of (i) kenaf fibers/particles and (ii) a mixture of (a) organic, granular, synthetic and/or oleophilic fibers/particles and (b)(i) one or more species of fungi selected from the group consisting of chaetonium indicum, chaetonium funicola, geotrichum candidum, macrophomina phaseolina, and trichoderma harziamum, and/or (b)(ii) one or more species of bacteria selected from the group consisting of bacillus subtillis, bacillus cereus sub group A and paenibacillus validus; (2) placing the device proximate a source of the liquid hydrocarbon to receive the liquid hydrocarbon directed thereto; and (3) bringing the liquid hydrocarbon into contact with the device.

From the foregoing it is believed that those skilled in the pertinent art will recognize the meritorious advancement of this invention and will readily understand that while the present invention has been described in association with one or more preferred embodiments thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. For example, certain types of coated/treated paper products may be substituted for the housing 22 or the textile material sheets 30, 32. Therefore, the embodiments of the invention in which an exclusive property or privilege is claimed are defined in the following appended claims and it is contemplated that the appended claims will cover any modifications or embodiments which fall within the scope of the invention.

What is claimed is:

1. A device for collecting and biodegrading a liquid hydrocarbon, said device comprising:
a pillow comprising at least one member of the group consisting of (i) kenaf particles and (ii) a mixture of (a) fibers and (b)(i) one or more species of fungi selected from the group consisting of chaetonium indicum, chaetonium funicola, geotrichum candidum, macrophomina phaseolina, and trichoderma harziamum, and/or (b)(ii) one or more species of bacteria selected from the group consisting of bacillus subtillis, bacillus cereus sub group A and paenibacillus validus.

2. The device of claim 1 wherein said fibers comprise organic fibers.

3. The device of claim 1 wherein said fibers comprise granular fibers.

4. The device of claim 1 wherein said fibers comprise synthetic fibers.

5. The device of claim 1 wherein said fibers comprise oleophilic fibers.

6. The device of claim 1 wherein said kenaf particles comprise inner core kenaf particles.

7. The device of claim 1 wherein said kenaf particles comprise outer bast kenaf particles.

8. The device of claim 1 wherein said kenaf particles comprise a mixture of inner core kenaf particles and outer bast kenaf particles.

9. The device of claim 1 wherein said pillow comprises a plurality of chambers each containing said at least one member of said group.

10. The device of claim 1 wherein said pillow is made from a needle-punched fabric.

11. The device of claim 10 wherein said fabric comprises polypropylene.

12. The device of claim 1 further comprising a housing made from a liquid impermeable material wherein said housing defines an opening to allow said liquid hydrocarbon to come into contact with said pillow.

13. The device of claim 12 wherein said housing comprises polyethylene.

14. The device of claim 12 wherein said device is substantially non-toxic about 30 to 45 days after said pillow is contacted with said liquid hydrocarbon.

15. The device of claim 9 further comprising a housing made from a liquid impermeable material in which said pillow is disposed wherein said housing comprises an upper sheet which defines an opening to allow said liquid hydrocarbon to come into contact with said pillow and wherein said pillow further defines a plurality of inter-connected channels wherein at least one of said channels comprises a first portion located opposite said opening and a second portion disposed underneath said upper sheet.

16. The device of claim 15 wherein said pillow further comprises a deflection portion disposed opposite said opening.

17. The device of claim 9 further comprising a housing made from a liquid impermeable material in which said pillow is disposed wherein said housing comprises an upper sheet which defines an opening to allow said liquid hydrocarbon to come into contact with said pillow and wherein said pillow further defines a plurality of inter-connected channels wherein at least one of said channels comprises a first portion located opposite said opening and first and second outer portions disposed underneath said upper sheet.

18. The device of claim 17 wherein each of said first and second outer portions of said at least one of said channels emanates from a perimeter of said pillow.

19. The device of claim 17 wherein said pillow further comprises a deflection portion disposed opposite said opening.

20. The device of claim 1 wherein said pillow comprises an upper sheet of a first fabric of a first density joined to a lower sheet of a second fabric of a second density, wherein said first density is less than said second density.

21. The device of claim 1 wherein said pillow comprises an upper sheet of a fabric of a first density joined to a lower sheet of said fabric of a second density, wherein said first density is less than said second density.

22. The device of claim 1 wherein said pillow contains a material consisting essentially of said kenaf particles.

23. The device of claim 1 wherein said pillow contains a material consisting essentially of said mixture.

24. The device of claim 1 wherein said pillow contains a material consisting essentially of a combination of said kenaf particles and said mixture.

25. A method of collecting and degrading a liquid hydrocarbon, comprising the steps of:
obtaining a device adapted to accumulate and biodegrade said liquid hydrocarbon, said device comprising a pillow comprising at least one member of the group consisting of (i) kenaf particles and (ii) a mixture of (a) fibers and (b)(i) one or more species of fungi selected from the group consisting of chaetonium indicum, chaetonium funicola, geotrichum candidum, macrophomina phaseolina, and trichoderma harziamum, and/or (b)(ii) one or more species of bacteria selected from the group consisting of bacillus subtillis, bacillus cereus sub group A and paenibacillus validus;
placing said device proximate a source of said liquid hydrocarbon to receive said liquid hydrocarbon directed thereto; and
bringing said liquid hydrocarbon into contact with said device.

26. The method of claim 25 wherein said fibers comprise organic fibers.

27. The method of claim 25 wherein said fibers comprise granular fibers.

28. The method of claim 25 wherein said fibers comprise synthetic fibers.

29. The method of claim 25 wherein said fibers comprise oleophilic fibers.

30. The method of claim 25 wherein said kenaf particles comprise inner core kenaf particles.

31. The method of claim 25 wherein said kenaf particles comprise outer bast kenaf particles.

32. The method of claim 25 wherein said kenaf particles comprise a mixture of inner core kenaf particles and outer bast kenaf particles.

33. The method of claim 25 wherein said pillow comprises a plurality of chambers each containing said at least one member of said group.

34. The method of claim 25 wherein said pillow is made from a needle-punched fabric.

35. The method of claim 34 wherein said fabric comprises polypropylene.

36. The method of claim 25 wherein said device further comprises a housing made from a liquid impermeable material wherein said housing defines an opening to allow said liquid hydrocarbon to come into contact with said pillow.

37. The method of claim 36 wherein said housing comprises polyethylene.

38. The method of claim 36 wherein said device is substantially non-toxic about 30 to 45 days after said pillow is contacted with said liquid hydrocarbon.

39. The method of claim 33 wherein said device further comprises a housing made from a liquid impermeable material in which said pillow is disposed wherein said housing comprises an upper sheet which defines an opening to allow said liquid hydrocarbon to come into contact with said pillow and wherein said pillow further defines a plurality of inter-connected channels wherein at least one of said channels comprises a first portion located opposite said opening and a second portion disposed underneath said upper sheet.

40. The method of claim 39 wherein said pillow further comprises a deflection portion disposed opposite said opening.

41. The method of claim 33 wherein said device further comprises a housing made from a liquid impermeable material in which said pillow is disposed wherein said housing comprises an upper sheet which defines an opening to allow said liquid hydrocarbon to come into contact with said pillow and wherein said pillow further defines a plurality of inter-connected channels wherein at least one of said channels comprises a first portion located opposite said opening and first and second outer portions disposed underneath said upper sheet.

42. The method of claim 41 wherein each of said first and second outer portions of said at least one of said channels emanates from a perimeter of said pillow.

43. The method of claim 41 wherein said pillow further comprises a deflection portion disposed opposite said opening.

44. The method of claim 25 wherein said pillow comprises an upper sheet of a first fabric of a first density joined to a lower sheet of a second fabric of a second density, wherein said first density is less than said second density.

45. The method of claim 25 wherein said pillow comprises an upper sheet of a fabric of a first density joined to a lower sheet of said fabric of a second density, wherein said first density is less than said second density.

46. The method of claim 25 wherein said pillow contains a material consisting essentially of said kenaf particles.

47. The method of claim 25 wherein said pillow contains a material consisting essentially of said mixture.

48. The method of claim 25 wherein said pillow contains a material consisting essentially of a combination of said kenaf particles and said mixture.

49. A device for collecting and biodegrading a liquid hydrocarbon, said device comprising:
a pillow comprising an upper sheet of a fabric of a first density joined to a lower sheet of said fabric of a second density, wherein said first density is less than said second density, said pillow also comprising a plurality of chambers each containing kenaf particles; and
a housing in which said pillow is disposed, wherein said housing comprises an upper sheet which defines an opening to allow said liquid hydrocarbon to come into direct contact with said pillow and wherein said pillow further defines a plurality of channels wherein at least one of said channels comprises a first portion located opposite said opening and a second portion disposed underneath said upper sheet.
